(19) United States
(12) Patent Application Publication
(10) Pub. No.: US 2012/0318136 A1
(43) Pub. Date: Dec. 20, 2012

(54) HOT GAS FILTRATION MEDIA AND FILTERS

(75) Inventors: ROBERT JOHN DUFF, Newark, DE (US); Zheng-Zheng Jenny Huang, Wilmington, DE (US); Lakshmi Krishnamurthy, Wilmington, DE (US); Rakesh Nambiar, Wilmington, DE (US); Joel M. Pollino, Elkton, MD (US); Joachim C. Ritter, Wilmington, DE (US); Harry Vaughn Samuelson, Chadds Ford, PA (US); Cheng-Hang Chi, Midlothian, VA (US)

(73) Assignee: E. I. DU PONT DE NEMOURS AND COMPANY, Wilmington, DE (US)

(21) Appl. No.: 13/160,830

(22) Filed: Jun. 15, 2011

(51) Int. Cl. B01D 46/00; B01D 46/46; B01D 46/02

(52) U.S. Cl. 95/20; 55/528; 55/361

(57) ABSTRACT

A nonwoven felt for hot gas filtration. The fibers have a polyarylene sulfide (PAS) component that contains a zinc compound. In one embodiment, the PAS comprises at least one zinc(II) salt of an organic carboxylic acid. Also a method for filtering hot gases employing a bag made from a PAS component that contains a zinc or a zinc based additive.

### FIELD OF INVENTION

This invention relates to the field of filtration media for hot gas filtration, and in particular media constructed from nonwoven webs or woven fabrics, and in particular webs formed from polyarylene sulfides.

### BACKGROUND OF INVENTION

Filter felts and bag filters for hot gas filtration containing aramid staple fibers, such as disclosed in U.S. Pat. Nos. 4,100,323 and 4,117,578 to Forsten are known and are used to protect the environment from particulate matter from asphalt plants, coal plants, and other industrial concerns. Due to the high potential environmental impact from such plants and the extreme chemical environment the filters must endure, any improvement that has the potential to improve the durability, filtration efficiency, and/or chemical resistance, is desired. Stability at higher operating temperatures is also a desirable feature of filters.

It is known to prepare fabrics and felts of crystalline poly(m-phenylene isophthalamide) fibers. These fabrics and felts are particularly useful in the filtration of hot gases, e.g. at 200° C. where other fibers such as polyester, acrylics, wool and nylon are not useful. Felts of crystalline poly(m-phenylene isophthalamide) fibers suffer from relatively poor dimensional stability and low strength. The lack of stability of these felts requires that the crystalline poly(m-phenylene isophthalamide) fiber batts be supported by a woven scrim to provide the required stability even though the poly(m-phenylene isophthalamide) fibers themselves have excellent dimensional stability. Even when supported by a scrim, crystalline poly(m-phenylene isophthalamide) fiber felts require calendaring to achieve a sufficiently low air permeability. Unfortunately, such calendared felts are not completely stable in use, the air permeability exhibiting an undesirable gradual increase with length of time in service.

This invention overcomes the deficiencies in previous felt by providing a high strength product with superior acid resistance at higher temperatures than heretofore.

### SUMMARY

The present invention is directed to a filtration media comprising a nonwoven web or woven fabric, also called herein as a filter felt, comprising fibers, said fibers comprising a polyarylene sulfide (PAS) wherein the polyarylene sulfide comprises a zinc compound as an additive. The fibers of the filter felt may be staple fibers and may further comprise a calcium salt, which may be calcium stearate.

The fibers of the filter media may be bonded by the process of hydroentangling or needle punching. The media may be scrimless or supported by scrims. The scrim may be made of polyarylene sulfide and may comprise zinc compound as an additive.

The zinc(II) additive comprises a zinc(II) carboxylate selected from the group consisting of Zn(O₂CR)₂, or Zn(O₂CR)(O₂CR′), or mixtures thereof, where the radicals R and R′ are independently hydrocarbon moieties or substituted hydrocarbon moieties. The carboxylate moieties O₂CR and O₂CR′ may independently represent either linear or branched alkyl carboxylate anions with the proviso that if R and R′ are both linear, then either one of them or both of them independently contains nine or less carbon atoms. In a preferred embodiment, the branched zinc(II) carboxylate comprises zinc octoate, which is zinc di-(2-ethyl hexanoate), where R═R′=—CH₂(C₂H₅)(CH₂)₃CH₃.

In a still further embodiment, the zinc additive forms a single phase system when combined with the PAS at above the melt temperature of the PAS.

The zinc additive may be present at a concentration of 0.1 to about 10 weight percent, based on the weight of the polyarylene sulfide.

In one embodiment the polyarylene sulfide is polyphenylene sulfide. In a further embodiment the fibers have been bonded by needlepunching to form a batt. In a still further embodiment the batt is needle punched to the extent of 460 to 775 needle penetrations/cm².

In a further embodiment the filter felt is in the form of a spunlaced felt. The denier per filament of the fibers may be from 1.5 to 3.5 (1.7 to 3.9 dtex per filament) or furthermore the denier per filament of the fibers may be from 1.5 to 2.5 (1.7 to 2.8 dtex per filament).

The filter felt may have a basis weight of from 8 to 16 ounces per square yard (270 to 540 grams per square meter) or of from 12 to 14 ounces per square yard (400 to 480 grams per square meter). The felt density may be from 0.2 to 0.3 g/cm³. The felt permeability may be from 6 to 12 m³/min./m².

The invention is further directed to a method for filtering industrial waste gases consisting of the steps of;
(i) providing a flow of dust laden gas,
(ii) allowing all of the flow of gas to impinge upon a filter felt while monitoring the pressure drop of the gas across the filter felt,
(iii) applying a back pulse to the filter felt in the opposite direction of the filter felt when the pressure drop reaches a predetermined level,
   wherein the filter felt comprises a nonwoven web comprising fibers, said fibers comprising a polyarylene sulfide (PAS) wherein the polyarylene sulfide comprises a zinc additive as described above.

The method of the invention may comprise the step of allowing all of the flow of gas to impinge on a filter felt as described in the previous paragraph where the filter felt may be any of the embodiments described above.

### DETAILED DESCRIPTION

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

### DEFINITIONS

As used herein the term “staple fiber” refers to fibers of discrete length which are formed by cutting of synthetic fibers made of extremely long lengths.

As used herein, the term “hydroentangled” is synonymous with “spunlaced” and means a nonwoven web formed by subjecting the fiber collection that the web comprises to water jets. An example of this process is described in U.S. Pat. No. 5,023,130, hereby incorporated in its entirety by reference.

As used herein the term “needlepunched” refers to fibers which have been formed by mechanically orienting and interlocking the fibers of a spunbonded or carded web. This mechanical interlocking may be achieved with felting needles repeatedly passing into and out of the web. Other definitions of needlepunched webs will be apparent to one skilled in the art and will apply to the webs described herein.

As used herein the term “nonwoven web” or “nonwoven material” means a web having a structure of individual fibers or filaments which are interlaid, but not in an identifiable manner as in a knitted or woven fabric. Nonwoven webs have been formed from many processes such as for example, meltblowing processes, spunbonding processes, air-laying processes and carded web processes. The fibers or filaments may be bonded or unbounded. If they are bonded they may be bonded by any method known to one skilled in the art, including thermal bonding, adhesive bonding, hydroentangling, and needle punching. The basis weight of nonwoven fabrics is usually expressed in grams per square meter (gsm) or ounces of material per square yard (osy) and the fiber diameters useful are usually expressed in microns. (Note that to convert from osy to gsm, multiply osy by 33.91). Polyarylene sulfides (PAS) include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ-(Ar³)ₖ—Z]ₗ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit. The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

### DESCRIPTION

The present invention is directed to a felt comprising a nonwoven web that in turn comprises fibers, said fibers comprising a polyarylene sulfide (PAS) component, in which the polyarylene sulfide component comprises a zinc compound.

The invention is also directed to a method for filtering hot gases using a felt comprising a nonwoven web that in turn comprises fibers, said fibers comprising a polyarylene sulfide (PAS) component, in which the polyarylene sulfide component comprises a zinc compound.

In one embodiment, the PAS comprises at least one zinc(II) salt of an organic carboxylic acid. The polyarylene sulfide composition may comprise at least one zinc additive comprising a zinc(II) carboxylate selected from the group consisting of Zn(O₂CR)₂, Zn(O₂CR)(O₂CR′), and mixtures thereof, where the radicals R and R′ are independently hydrocarbon moieties or substituted hydrocarbon moieties. The carboxylate moieties O₂CR and O₂CR′ may independently represent either linear or branched alkyl carboxylate anions with the proviso that if R and R′ are both linear, then either one of them or both of them independently contains nine or less carbon atoms. In a preferred embodiment, the branched zinc(II) carboxylate comprises zinc octoate, which is zinc di-(2-ethyl hexanoate), where R═R′=—CH₂(C₂H₅)(CH₂)₃CH₃.

By “linear” when referring to an alkyl hydrocarbon chain is meant that there are no secondary or tertiary carbon atoms in the alkyl chain. A branched chain will have at least one either secondary or tertiary carbon atom or both.

In a still further embodiment, the zinc additive forms a single phase system when combined with the PAS at above the melt temperature of the PAS.

The zinc additive may be present at a concentration of 0.1 to about 10 weight percent, based on the weight of the polyarylene sulfide.

Generally, the relative amounts of the branched and linear zinc(II) carboxylates are selected such that the sum of the branched carboxylate moieties [O₂CR+O₂CR′] is at least about 25%, and prefereably between 25% and 100% on a molar basis of the total carboxylate moieties [O₂CR+O₂CR′] contained in the additive. For example, the sum of the branched carboxylate moieties may be at least about 33%, or at least about 40%, or at least about 50%, or at least about 66%, or at least about 75%, or at least about 90%, of the total carboxylate moieties contained in the zinc additive.

In one embodiment, the radicals R and R′ both contain at least one secondary or tertiary carbon. The secondary or tertiary carbon(s) may be located at any position(s) in the carboxylate moieties O₂CR and O₂CR′, for example in the position a to the carboxylate carbon, in the position ω to the carboxylate carbon, and at any intermediate position(s). The radicals R and R′ may be unsubstituted or may be optionally substituted with inert groups, for example with fluoride, chloride, bromide, iodide, nitro, hydroxyl, and carboxylate groups. Examples of suitable organic R and R′ groups include aliphatic, aromatic, cycloaliphatic, oxygen-containing heterocyclic, nitrogen-containing heterocyclic, and sulfur-containing heterocyclic radicals. The heterocyclic radicals may contain carbon and oxygen, nitrogen, or sulfur in the ring structure.

In one embodiment, the radical R″ is optionally substituted with inert groups, for example with fluoride, chloride, bromide, iodide, nitro, hydroxyl, and carboxylate groups. In one embodiment, the radical R″ is a primary alkyl group.

In one embodiment, the radicals R or R′ independently or both have a structure represented by Formula (I),

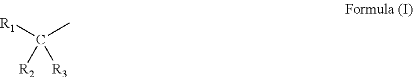

wherein R₁, R₂, and R₃ are independently:

H;

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R₁ is:

a secondary or tertiary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In another embodiment, the radicals R or R′ or both have a structure represented by Formula (II),

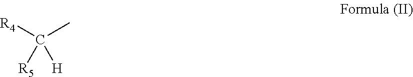

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the radicals R and R′ are the same and both have a structure represented by Formula (II), where R₄ is n-butyl and R₅ is ethyl. This embodiment describes the branched zinc(II) carboxylate zinc(II) 2-ethylhexanoate, also referred to herein as zinc(II) ethylhexanoate.

The zinc(II) carboxylate(s) may be obtained commercially, or may be generated in situ from an appropriate source of zinc(II) cations and the carboxylic acid corresponding to the desired carboxylate(s). The zinc(II) additive may be present in the polyarylene sulfide at a concentration sufficient to provide improved thermo-oxidative and/or thermal stability. In one embodiment, the zinc(II) additive may be present at a concentration of about 10 weight percent or less, or even 0.1 to 10 weight-%, based on the weight of the polyarylene sulfide. The zinc(II) additive may further be present at a concentration of about 0.01 weight percent to about 5 weight percent, or for example from about 0.25 weight percent to about 2 weight percent. Typically, the concentration of the zinc(II) additive may be higher in a master batch composition, for example from about 5 weight percent to about 10 weight percent, or higher. The zinc(II) additive may be added to the molten or solid polyarylene sulfide as a solid, as a slurry, or as a solution.

In a further embodiment, the polyarylene sulfide composition of the sheath of the fibers of the invention may differ from a core layer of the fibers and the sheath further comprises at least one zinc(II) additive as described above, and/or zinc metal [Zn(0)]. The zinc(II) additive may be an organic additive, for example zinc octoate, or an inorganic compound such as zinc sulfate or zinc oxide, as long as the organic or inorganic counter ions do not adversely affect the desired properties of the polyarylene sulfide composition. The zinc(II) additive may be obtained commercially, or may be generated in situ. Zinc metal may be used in the composition as a source of zinc(II) ions, alone or in conjunction with at least one zinc(II) additive. In one embodiment the zinc(II) additive is selected from the group consisting of zinc oxide, zinc octoate, and mixtures thereof.

The zinc(II) additive and/or zinc metal may be present in the polyarylene sulfide at a concentration of about 10 weight percent or less, based on the weight of the polyarylene sulfide. For example, the zinc(II) additive and/or zinc metal may be present at a concentration of about 0.01 weight percent to about 5 weight percent, or for example from about 0.25 weight percent to about 3 weight percent. Typically, the concentration of the zinc(II) additive and/or zinc metal may be higher in a master batch composition, for example from about 5 weight percent to about 10 weight percent, or higher. The at least one zinc(II) additive and/or zinc metal may be added to the molten or solid polyarylene sulfide as a solid, as a slurry, or as a solution.

The felt may comprise staple fibers. It may be hydroentangled or needlepunched. When the fibers have been bonded by needlepunching to form a batt, in one embodiment, the batt is needle punched to the extent of 460 to 775 needle penetrations/cm².

In one embodiment, the denier per filament of the fibers may be from 1.5 to 3.5 (1.7 to 3.9 dtex per filament). In a further embodiment, the denier per filament of the fibers is 1.5 to 2.5 (1.7 to 2.8 dtex per filament).

In one embodiment, the felt may have a basis weight of from 8 to 16 ounces per square yard (270 to 540 grams per square meter) or even from 12 to 14 ounces per square yard (400 to 480 grams per square meter).

In one embodiment, the felt may comprise a scrim that in turn comprises fibers, said fibers comprising a polyarylene sulfide (PAS) component, in which the polyarylene sulfide component comprises a zinc compound.

The felt of the invention may have a felt density is 0.2 to 0.3 g./cm³. The felt of the invention may further have a permeability is 6 to 12 m³/min./m².

The invention is also directed to a bag filter comprising the filter felt of the invention, the bag filter having a tubular section, one closed end and one open end, wherein the filter felt is a nonwoven felt and forms at least the tubular section of the bag filter.

The invention is further directed to a method for filtering industrial waste gases comprising the steps of;
(i) providing a flow of dust laden gas,
(ii) allowing all of the flow of gas to impinge upon a filter felt while monitoring the pressure drop of the gas across the filter felt,
(iii) applying a back pulse to the filter felt in the opposite direction of the filter felt when the pressure drop reaches a predetermined level,
   wherein the filter felt comprises a nonwoven web comprising fibers, said fibers comprising a polyarylene sulfide (PAS) wherein the polyarylene sulfide comprises a zinc additive as described above.

The method of the invention may comprise of allowing all of the flow of gas to impinge on a filter felt as described in the previous paragraph where the filter felt may be any of the embodiments described above.

### EXAMPLES

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### MATERIALS

The following materials were used in the examples. All commercial materials were used as received unless otherwise indicated. Fortron® 309 polyphenylene sulfide and Fortron® 317 polyphenylene sulfide were obtained from Ticona Coporation of Florence, Ky. Kadox 930 Zinc Oxide was obtained from Horsehead Corporation of Pittsburgh, Pa. Zinc stearate, 99% purity, was obtained from The Struktol Company of Stow, Ohio. Zinc Octoate (CAS#136-53-8) and Zinc Caprylate (CAS#557-09-5) were obtained from The Shepherd Chemical Company of Norwood, Ohio. For the following examples and for comparison among zinc additives, zinc compounds were compounded into polyphenylene sulfide in amounts that resulted in equimolar amounts of zinc per weight of compound among all compositions.

### ANALYTICAL METHODS

The thermo-oxidative stability of PPS compositions was assessed by measuring changes in melting point (Tm) as a function of exposure time in air. In one analysis method, solid PPS compositions were exposed in air at 250° C. for 10 days. In another analysis method, molten PPS compositions were exposed in air at 320° C. for 3 hours. In each analysis method, melting point Page 12 of 33 retention was quantified and reported as Δ Tm (° C.) and Rel. Δ Tm (%), where:

Δ Tm (° C.)=Tm (initial)−Tm (final)

and

Rel. Δ Tm (%)=[1−(Δ Tm (sample)/Δ Tm (control))]×100

In the 250° C. method, samples (1-5 g) of the compositions of the Examples and the Comparative Examples were weighed and placed in a 2 inch circular aluminum pan on the middle rack of a 250° C. preheated convection oven with active circulation. After 10 days of air aging the samples were removed and stored for evaluation by differential scanning calorimetry (DSC). DSC was performed using a TA instruments Q100 equipped with a mechanical cooler. Samples were prepared by loading 8-12 mg of air-aged polymer into a standard aluminum DSC pan and crimping the lid. The temperature program was designed to erase the thermal history of the sample by first heating it above its melting point from 35° C. to 320° C. at 10° C./min and then allowing the sample to re-crystallize during cooling from 320° C. to 35° C. at 10° C./min. Reheating the sample from 35° C. to 320° C. at 10° C./min afforded the melting point of the air-aged sample, which was recorded and compared directly to the melting point of a non-aged sample of the same composition. The entire temperature program was carried out under a nitrogen purge at a flow rate of 50 mL/min. All melting points were quantified using TA's Universal Analysis software via the software's linear peak integration function.

In the 320° C. method, samples (8-12 mg) of the compositions of the Examples and the Comparative Examples were placed inside a standard aluminum DSC pan without a lid. DSC was performed using a TA instruments Q100 equipped with a mechanical cooler. The temperature program was designed to melt the polymer under nitrogen, expose the sample to air at 320° C. for 20 min, crystallize the air-exposed sample under nitrogen, and then reheat the sample to identify changes in the melting point. Thus, each sample was heated from 35° C. to 320° C. at 20° C./min under nitrogen (flow rate: 50 mL/min) and held isothermally at 320° C. for 5 min, at which point the purge gas was switched from nitrogen to air (flow 50 mL/min) while maintaining a temperature of 320° C. for 180 minutes. Subsequently, the purge gas was switched back from air to nitrogen (flow rate: 50 mL/min) and the sample was cooled from 320° C. to 35° C. at 10° C./min and then reheated from 35° C. to 320° C. at 10° C./min to measure the melting point of the air-exposed material. All melt curves were bimodal. The melting point of the lower melt was quantified using TA's Universal Analysis software via the software's inflection of the onset function.

In the Tables, “Ex” means “Example”, “Comp Ex” means “Comparative Example”, and “Δ” means “difference”.

### DEGRADATION OF FILTER FELTS

DSC melting points were described as above. The margin of error for Tm is +−1° C.

In order to establish a relation between the melting point of degraded filter felts and the degree of degradation of the felts themselves, used filter bag samples were analyzed and compared to unused sample.

Filter bag samples were cut from unused PPS filter felt by cutting 14×20 cm sheets. The sheets were hung inside a convection oven (Lindberg model “Blue M”) with a 2.75 g tension weight attached to the short side of the sheet and aged at 250° C. for the time specified. Small samples for DSC analysis and samples of 5×6 cm for tensile strength and tear strength measurements were cut at the specified time and the sheet was returned to the oven for further aging.

The tensile measurements were conducted according to ISO9073 standards with the exception of changing the sample size to 25 mm×50 mm instead of the ISO9073 standard of 50 mm×200 mm.

Tensile breaking strength and elongation at break were determined using a constant rate of extension testing apparatus. Tear strength measurements were conducted according to ISO13937-2 with the exception of changing the sample size to 50 mm×50 mm instead of the ISO9073 standard of 50 mm×200 mm.

“Unused filter or filter bag material” describes a filter bag or filterbag material which has not been exposed to heat after the manufacturing process. “Aged filter or filter bag material” describes “Unused filter or filter bag material” which has been exposed to 250° C. air in an oven for a specified time as described above.

“Unused filter or filter bag material” is a material which has been used in a bag house of a coal fire boiler plant filter unit.

This comparative example shows melting points Tm for unused and used filter bags:

TABLE 1

| Time in | | | | Tear strength | Elongation at |
|---|---|---|---|---|---|
| bag house | Filter | | | relative | break relative |
| [month] | brand | Tm | status | change | change |
| New | (A) | 281 | functional | 0% | 0% |
| 5 | (A) | 270 | functional | −60% | −40% |
| 10 | (A) | 262 | failed | −80% | −70% |
| 12 | (B) | 251 | failed | −85% | −85% |

Table 2 shows the change of Tm, relative changes for tensile strength (Tensile strength), relative changes for elongation at break (Elongation at break) and relative changes for tear strength (Tear Strength) of an unused filter bag after aging at 250° C. in air reaching a failure characteristic values at about day 30:

TABLE 2

| Aged Felt | | Tensile | Elongation | Tear |
|---|---|---|---|---|
| t [d] | Tm | strength | at break | Strength |
| 0 | 281 | 0% | 0% | 0% |
| 1 | 280 | −3% | −5% | −14% |
| 2 | 277 | −13% | −13% | −40% |
| 4 | 274 | −15% | −16% | −40% |
| 21 | 266 | −44% | −58% | −75% |
| 30 | 263 | −65% | −75% | <−75% |

Table 3 following shows the change of melting point of unused filter bags after exposure to air at 250° C. reaching a failure characteristic Tm at about day 30.

TABLE 3

| | Tm |
|---|---|
| t [d] | (° C.) |
| 0 | 281 |
| 2 | 277 |
| 4 | 274 |
| 8 | 272 |
| 11 | 271 |
| 14 | 270 |
| 21 | 266 |
| 30 | 263 |

In view of the above results, in some of the following examples, the melting point of the resin after aging and hence thermo oxidative degradation will be used to ascertain the extent of degradation that the resin or fiber has been subjected.

### Master Batch Procedure

Example Master Batch A (Zinc Stearate)

The PPS composition containing 10 weight percent Zinc Stearate was produced using an extrusion process. Fortron®0309 PPS (93.4 parts) was melt compounded in a Coperion 18 mm intermeshing co-rotating twin-screw extruder with a side stuffer adding Zinc Stearate (6.6 parts) down stream into the melted polymer. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized to give a pellet count of 100-120 pellets per gram.

Example Master Batch B (Zinc Octoate)

The PPS composition containing 5.5 weight percent Zinc Octoate was produced using an extrusion process. Fortron®0309 PPS (94.5 parts) was melt compounded in a Coperion 18 mm intermeshing co-rotating twin-screw extruder with a liquid metering pump adding Zinc Octoate (5.5 parts) down stream into the melted polymer. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized to give a pellet count of 100-120 pellets per gram.

Example Master Batch C (Zinc Oxide)

The PPS composition containing 1.4 weight percent Zinc Oxide was produced using an extrusion process. Fortron®0309 PPS (98.6 parts) was melt compounded in a Coperion 18 mm intermeshing co-rotating twin-screw extruder with gravimetric twin screw feeder adding Zinc Oxide (1.4 parts) at the feed throat prior to polymer melt. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized to give a pellet count of 100-120 pellets per gram.

### Spinning Procedure

Fibers in the following examples had 34 filaments and denier per fiber was 3.2.

### Example Fiber A (PPS 309)

Fortron® 309 PPS pellets were dried for 16 hours at 120° C. in a vacuum oven with a dry nitrogen sweep. The dried polymer pellets was metered into a Werner and Pfleiderer 28 mm twin screw extruder and spun through a 34-hole spinneret orifice of 0.012 inch (0.030 mm) diameter and 0.048 inch (1.22 mm) length. The extruder was heated as follows: in the feed zone to 190° C., in the melt zones at 280° C. then 285° C., in the transfer zones at 285° C., and in the Zenith pumps (Zenith Pumps, Monroe, N.C.) at 285° C. The molten polymer was transferred to the spinneret pack block at 290° C. A ring heater was used at 295° C. around the pack nut holding the spinneret. After simple cross flow air quenching, fully drawn yarns were processed as described below. The wind up unit was a Barmag SW 6.

The speed of the gear pump was preset so as to supply 23.8 g/min of the PPS composition to the spinneret. The polymer stream was filtered through three 200 mesh screens sandwiched between 50 mesh screens within the pack, and after filtration, a total of 34 individual filaments were created at the spinneret orifice outlets. These 34 resulting filaments were cooled in an ambient air quench zone using simple cross flow air quenching, given an aqueous oil emulsion (10% oil) finish, and then combined in a guide approximately eight feet (˜7 meters) below the spin pack to produce a yarn. The 34 filament yarn was pulled away from the spinneret orifices and through the guide by a roll with an idler roll turning at approximately 520 meters per minute. From these rolls the yarn was taken to a pair of rolls also at 530 meters per minute, then through a steam jet at 175° C., then to a pair of rolls at 1900 meters per minute heated at 125° C., then to a pair of rolls at 1875 meters per minute then to a pair of let down rolls at 1875 meters per minute and to the windup roll (Barmag SW 6) at 1875 meters per minute to give a draw ratio of 3.6×.

### Example Fiber B (PPS 309/317)

Fortron 309 resin and Fortron 317 resin were dried for 16 hours at 120° C. in a vacuum oven with a dry nitrogen sweep. Dried Fortron 309 resin (70 parts) and dried Fortron 317 resin (30 parts) were mixed well in a plastic container and the pellet mixture was metered into a Werner and Pfleiderer 28 mm twin screw extruder and spun to give Fiber B in the same way as Fiber A.

### Example Fiber C

Fortron 309 resin and Masterbatch A were dried for 16 hours at 120° C. in a vacuum oven with a dry nitrogen sweep. Dried Fortron 309 resin (60 parts) and Masterbatch A (40 parts) were mixed well in a plastic container and the pellet mixture was metered into a Werner and Pfleiderer 28 mm twin screw extruder and spun to give Fiber C in the same way as Fiber A. The fiber could only be drawn till 3.2× and had lot of breaks.

### Example Fiber D

Fortron 309 resin and Masterbatch B were dried for 16 hours at 120° C. in a vacuum oven with a dry nitrogen sweep. Dried Fortron 309 resin (60 parts) and Masterbatch B (40 parts) were mixed well in a plastic container and the pellet mixture was metered into a Werner and Pfleiderer 28 mm twin screw extruder and spun to give Fiber D in the same way as Fiber A.

### Example Fiber E

Fortron 309 resin and Masterbatch C were dried for 16 hours at 120° C. in a vacuum oven with a dry nitrogen sweep. Dried Fortron 309 resin (60 parts) and Masterbatch C (40 parts) were mixed well in a plastic container and the pellet mixture was metered into a Werner and Pfleiderer 28 mm twin screw extruder and spun to give Fiber E in the same way as Fiber A.

### Example Fiber F

Fortron 309 resin, Fortron 317 resin and Masterbatch B were dried for 16 hours at 120° C. in a vacuum oven with a dry nitrogen sweep. Dried Fortron 309 resin (30 parts), Fortron 317 resin (30 parts) and Masterbatch B (40 parts) were mixed well in a plastic container and the pellet mixture was metered into a Werner and Pfleiderer 28 mm twin screw extruder and spun to give Fiber F in the same way as Fiber A.

### Example Fiber G

Fortron 309 resin, Fortron 317 resin and Masterbatch C were dried for 16 hours at 120° C. in a vacuum oven with a dry nitrogen sweep. Dried Fortron 309 resin (30 parts), Fortron 317 resin (30 parts) and Masterbatch C (40 parts) were mixed well in a plastic container and the pellet mixture was metered into a Werner and Pfleiderer 28 mm twin screw extruder and spun to give Fiber G in the same way as Fiber A.

### Example Fiber H

Fortron 309 resin, Masterbatch B and Masterbatch C were dried for 16 hours at 120° C. in a vacuum oven with a dry nitrogen sweep. Dried Fortron 309 resin (20 parts), Masterbatch B (40 parts) and Masterbatch C (40 parts) were mixed well in a plastic container and the pellet mixture was metered into a Werner and Pfleiderer 28 mm twin screw extruder and spun to give Fiber H in the same way as Fiber A.

The results of tensile testing on these samples are given in table 4 below, where ZnSt is zinc stearate, ZnOct is zinc octoate and ZnO is zinc oxide. Tenacity and elongation were measured on an Instron 5500 Retrofit 1122 testing machine using fibers with 3 twists per inch and a gage length of 10 inch and a cross head speed of 6 inches per min. The tenacity and elongation reported are at maximum load.

TABLE 4
Tenacity and Elongation Data of PPS fibers with Additives

| | | Additive and | | Tensile | |
|---|---|---|---|---|---|
| | | Level in PPS | | Strength | Elongation |
| Example | Resin | layer. | | (kg/cm) | (%) |
| Fiber A | 309 | None | | 3.44 | 21.44 |
| (Comparative) | | | | | |
| Fiber B | 309/317 | None | | 3.32 | 17.16 |
| (Comparative) | | | | | |
| Fiber C | 309 | 4% | ZnSt | 2.65 | 17.53 |
| Fiber D | 309 | 2.56% | ZnOct | 3.14 | 20.91 |
| Fiber E | 309 | 0.56% | ZnO | 3.46 | 21.52 |
| Fiber F | 309/317 | 2.56% | ZnOct | 3.20 | 19.13 |
| Fiber G | 309/317 | 0.56% | ZnO | 3.36 | 17.35 |
| Fiber H | 309 | 2.56% | ZnOct | 3.33 | 22.3 |
| | | 0.56% | ZnO | | |

Although Zinc stearate and Zinc Octoate are both liquids at the processing temperature, there is a difference in spinning continuity and resultant fiber tenacities. Zinc Stearate containing fibers had lower tenacities and considerable fiber breaks when spinning. This was postulated to be due to the lack of miscibility of the two components. Zinc stearate is immiscible in PPS whereas zinc Octoate is miscible.

### Miscibility of Additives in Polymer Melt

Miscibility of additive with polymer melt was determined by the following procedure. PPS powder and zinc stearate were mixed using a Waring style blender at various concentrations, and melted under nitrogen in the TA instruments Q100 equipped with a Refrigerated Cooling System differential scanning calorimeter from room temperature to 320° C. then isothermed at 320° C. for to ensure complete melting and mixing. The sample was then cooled back to room temperature then reheated to observe the melt point of both zinc stearate and PPS. The melt points were found between 100° C. and 130° C. using the TA Universal Analysis Software's Signal Maximum Function and shown in table 5.

TABLE 5

| Weight | Zinc Stearate |
|---|---|
| Percentage | Melt Peak |
| Zinc Stearate | Found (yes/no) |
| 20 | Yes |
| 10 | Yes |
| 7 | Yes |
| 5 | Yes |
| 4 | Yes |
| 3 | No |
| 2 | No |
| 1.5 | No |
| 1 | No |

Zinc Octoate was melt extruded in PPS with using a twin screw intermeshing co-rotating extruder at various concentrations. The sample were melted under nitrogen in TA instruments Q100 equipped with a Refrigerated Cooling System differential scanning calorimeter from −90 to 320° C. then isothermed at 320° C. to ensure complete melting and mixing. The sample was then cooled back to −90° C. then reheated to observe the melt point of both zinc octoate and PPS. The melt points were found between −70° C. and 0° C. using the TA Universal Analysis Software's Signal Maximum Function. See table 6.

TABLE 6

| | Zinc Octoate |
|---|---|
| Percentage | Melt Peak |
| Zinc Octoate | Found (yes/no) |
| 16.5 | No |
| 5.5 | No |
| 2.2 | No |

The presence of a separate melting peak found in the Zinc Stearate indicates an immiscibility or insolubility of the additive in the PPS polymer matrix. At low concentrations, below 4%, the separated melt peak is not observed because of the low energy required to melt such a small amount of additive compared to the energy required to heat the polymeric material. The Zinc Octoate does not show this phenomenon at the reported melting range for the neat material, around −45 C. This would indicate miscibility of the additive in the PPS resin matrix.

### Fiber Aging in Hot Air Oven

To determine thermal-oxidative degradation behavior of fibers, the fiber samples were aged in hot convective ovens with circulating air (TPS Blue M ovens). The aging temperature used was either 250° C. or 220° C. A constant tension of 0.1 grams per denier was applied to the fiber throughout the aging process. Some samples were aged for 10 minutes under 0.1 grams per denier tension as a way to heat-set the fiber. Fibers were about 110 denier. The heat-set fiber was used as the baseline for property comparisons. Other samples were aged for 5 to 100 days and removed from the oven for tensile property measurement as described below.

### Fiber Straight and Loop Tensile Property Measurement

Tensile breaking strength and elongation at break of fiber were determined using a constant rate of extension testing apparatus according to ASTM D 2256-02 test method except for sample gauge length and the rate of extension. The gauge length of the sample was 8 inches (20.32 cm) and the rate of extension was 10 in/min (25.4 cm/min.) As in standard textile testing, a 3 turns per inch Z-twist was applied to the sample with a hand twister. Both the straight tensile and loop tensile tests were conducted. As described in the ASTM test method, the loop test provides some indication of brittleness of the fiber.

The additives disclosed in this invention can slow down crosslinking and embrittlement of the fiber, the latter can be reflected in the decrease of elongation at break (Eb) in the straight tensile and/or loop tensile tests. This is illustrated in tables 7 and 8 that show the results at 220° C. and 250° C. respectively. The inclusion of zinc octoate slows down the decrease in Eb due to aging in hot air for both samples at both temperatures.

TABLE 7
Retention of Eb after 45 days at 220° C.

| | Configuration | Addtives | % Retention | % Retention |
|---|---|---|---|---|
| | S = Straight | ZnOct = Zinc | of Eb at 45 | of Eb at 73 |
| Resin | L = Loop | Octoate | Days | Days |
| 309 | S | No | 59.5 | 33.1 |
| 309 | S | ZnOct | 74.1 | 64.1 |
| 309 | L | No | 43.1 | 18.3 |
| 309 | L | ZnOct | 64.5 | 62.0 |

TABLE 8
Retention of Eb after 15 days at 250° C.

| | Configuration | Addtives | % Retention of |
|---|---|---|---|
| | S = Straight | ZnOct = Zinc | Eb at 15 |
| Resin | L = Loop | Octoate | Days |
| 309 | S | No | 50.4 |
| 309 | S | ZnOct | 61.7 |
| 309 | L | No | 32.1 |
| 309 | L | ZnOct | 35.6 |
| 309/317 | L | No | 29.6 |
| 309/317 | L | ZnOct | 38.9 |

### Differential Scanning Calorimetry Measurements

Thermo-oxidative stability of PPS compositions was assessed by changes in the melting point (Tm) as a function of exposure time in air at elevated temperature. Examples were prepared with equimolar amounts of Zinc relative to the total composition weight. PPS compositions, in the physical forms including pellets, powder or fibers, were exposed at 250° C. over a period of time lasting from 5 to 100 days, usually till a failure point was reached. Based on historical data using PPS filter bag tensile properties versus melt point retention, 265° C. was determined to be the Tm of failure corresponding to physical failure. The analysis of this method was quantified and reported as the time (days) to reach the Tm of failure as compared to a comparative example or control PPS composition, usually of the same physical form, thermal history and without stabilizer or additive.

In the 250° C. Air Aging (250 C A-A) Method, samples (>20 g) of the compositions of the examples, controls and comparative examples were weighed and separated in a 2 inch circular aluminum pan and placed into a 250° C. preheated mechanical convection oven with active circulation. After a period of time, usually every 7 days, an aliquot of each sample was removed and stored at room temperature to stop the aging process while the remaining sample continued to age in the oven. Each aged sample time point was analyzed by differential scanning calorimetry (DSC). DSC was performed using a TA Instruments Q100 equipped with a TA Instruments Refrigerated Cooling System. Samples were prepared by accurately weighting 2-25 mg of PPS composition in to a standard aluminum DSC pan. The temperature program was designed to erase the thermal history of the sample by first heating it above its melting point form 35° C. to 320° C. at 20 K/min and then allowing the sample to re-crystallize during cooling from 320° C. to 35° C. at 10 K/min. Reheating the sample from 35° C. to 320° C. at 10 K/min afforded the melting point of the sample, which was recorded and compared directly to the melting point of corresponding examples, comparative examples and control PPS compositions. The entire temperature program was carried out under a nitrogen purge at a flow rate of 50 mL/min. All melting points were quantified using TA's Universal Analysis software via the software linear peak integration function and are shown in table 9.

TABLE 9
Thermo oxidative stability by Melt Point
Depression through Air Aging (250° C. A-A)

| | | Time Aged to |
|---|---|---|
| | | Critical |
| | | Melt point |
| Example | Description | (days) |
| A | Control 309 fiber | 52 |
| B | Control 309/317 blend fiber | 40 |
| C | 2.6% Zinc Stearate in 309 fiber | 61 |
| D | 2.2% Zinc Octoate in 309 Fiber | 75 |
| E | 0.52% Zinc Oxide in 309 Fiber | no data |
| | 2.2% Zinc Octoate in 309/317 | |
| F | blend fiber | 87 |
| | 0.52% Zinc Oxide in 309/317 | |
| G | blend fiber | 59 |

### Molecular Weight Measurements

The thermal stability of PPS compositions was also assessed by measuring changes in weight-averaged molecular weight (Mw) and number-averaged molecular weight (Mn) on aging under nitrogen or air at 250° C. as a function of time.

The molecular weights of the PPS fibers were measured using an integrated multidetector SEC system PL-220™ from Polymer Laboratories Ltd., now a part of Varian Inc. (Church Stretton, UK). Constant temperature was maintained across the entire path of a polymer solution from the injector through the four on-line detectors: 1) a two-angle light scattering photometer, 2) a differential refractometer, 3) a differential capillary viscometer, and 4) an evaporative light scattering photometer (ELSD). The system was run with closed valves for the ELSD detector, so that only traces from the refractometer, viscometer and light scattering photometer were collected. Three chromatographic columns were used: two Mix-B PL-Gel columns and one 500A PL Gel column from Polymer Labs (10 μm particle size). The mobile phase was comprised of 1-chloronaphthalene (1-CNP) (Acros Organics), which was filtered through a 0.2 micron PTFE membrane filter prior to use. The oven temperature was set to 210° C.

Typically, a PPS sample was dissolved for 2 hours in 1-CNP at 250° C. with continuous moderate agitation without filtration (Automatic sample preparation system PL 260™ from Polymer Laboratories). Subsequently, the hot sample solution was transferred into a hot (220° C.) 4 mL injection valve at which point it was immediately injected and eluted in the system. The following set of chromatographic conditions was employed: 1-CNP temperature: 220° C. at injector, 210° C. at columns and detectors; flow rate: 1 mL/min, sample concentration: 3 mg/mL, injection volume: 0.2 mL, run time: 40 min. Molecular weight distribution (MWD) and average molecular weights of PPS were then calculated using a multidetector SEC method implemented in Empower™ 2.0 Chromatography Data Manager from Waters Corp. (Milford, Mass.).

TABLE 10
Molecular Weight Data for Samples Aged at 250° C. Under Air

| | | Mw 0 day | Mw 5 day | Mw 10 day |
|---|---|---|---|---|
| Sample | Additive(s) | (kDa) | (kDa) | (kDa) |
| Fiber B | none | 64.3 | 68.0 | 102.3 |
| Fiber F | 2.56% ZnOct | 64.3 | 65.4 | 61.0 |
| Fiber G | 0.52% ZnO | 64.3 | 66.2 | 90.3 |

The molecular weight data in Table 10 indicate that the PPS 309/317 fiber (Fiber G) increases in Mw (due to crosslinking) from 64.3 kDa to 102.3 kDa on aging in air at 25° C. for 10 days. Addition of ZnOct however suppresses the increase in Mw under similar conditions. Smaller increase in Mw (from 64.3 to 61.0 kDa) in air indicates greater thermo-oxidative stability of PPS fiber with Zinc Octoate additive. In the case of Fiber G with 0.52% zinc oxide, the Mw increases from 64.3 kDa to 90.3 kDa indicating that zinc oxide is not very effective in retarding the crosslinking of PPS.

TABLE 11
Molecular Weight Data for Samples
Aged at 250° C. Under Nitrogen

| | | Mn 0 day | Mn 5 day | Mn 10 day |
|---|---|---|---|---|
| Sample | Additive(s) | (kDa) | (kDa) | (kDa) |
| Fiber B | none | 19.7 | 13.2 | 13.9 |
| Fiber F | 2.56% ZnOct | 19.7 | 18.3 | 17.0 |
| Fiber G | 0.52% ZnO | 19.7 | 18.9 | 17.5 |

The molecular weight data in Table 11 indicate that the PPS 309/317 fiber (Fiber B) decreases in Mn (due to chain scission) from 19.7 kDa to 13.9 kDa on aging in nitrogen at 25° C. for 10 days. Addition of ZnOct (Fiber F) as well as ZnO (Fiber G) however suppresses the decrease in Mn from 19.7 kDa to 17.0 kDa and from 19.7 kDa to 17.5 kDa respectively under similar conditions. Smaller decrease in Mn under nitrogen conditions indicates greater thermo-oxidative stability of PPS fiber due to lower chain scission.
Based on molecular weight data from Table 10 and 11, Zinc octoate additive decelerates both crosslinking as well as chain scission reactions in PPS while Zinc oxide additive is effective in retarding the chain scission reaction in PPS.

Although particular embodiments of the present invention have been described in the foregoing description, it will be understood by those skilled in the art that the invention is capable of numerous modifications, substitutions, and rearrangements without departing from the spirit of essential attributes of the invention.

What is claimed is:

1. A filter felt containing fibers, said fibers comprising a composition containing polyarylene sulfide (PAS) wherein the polyarylene sulfide comprises a zinc additive in which the zinc additive comprises a linear or branched zinc(II) carboxylate selected from the group consisting of Zn(O₂CR)₂, or Zn(O₂CR)(O₂CR′), or mixtures thereof, where the radicals R and R′ are independently hydrocarbon chains or substituted hydrocarbon chains, and if the hydrocarbon chains are alkyl chains then the carboxylate moieties O₂CR and O₂CR′ independently represent either linear or branched carboxylate anions with the proviso that if R and R′ are both linear, then either one of them or both of them independently contains nine or less carbon atoms.

2. The felt of claim 1 in which the zinc additive is present in an amount for which it is completely miscible in the polyarylene sulfide when the polyarylene sulfide is at above its melt temperature where miscibility is measured by mixing additive and polymer, melting the mixed additive plus polymer under nitrogen in a calorimeter, cooling to a temperature below the melting point of the pure additive and reheating to observe both the melting point of the polymer and that of the additive, and wherein miscibility means that within the limit of precision of the calorimeter no additive melt transition is seen.

3. The felt of claim 1 in which the zinc additive comprises zinc octoate.

4. The felt of claim 1 in which the polyarylene sulfide further comprises a calcium salt.

5. The felt of claim 4 in which the calcium salt is calcium stearate.

6. The felt of claim 1 in which the zinc additive further comprises a linear zinc(II) carboxylate Zn(O₂CR″)₂ in which the alkyl groups R″ are linear and independently contain nine or more carbon atoms.

7. The felt of claim 1 in which the hydrocarbon chains are alkyl chains and sum of the branched carboxylate moieties O₂CR and O₂CR′ is between 25% and 100% on a molar basis of the total carboxylate moieties contained in the zinc additive.

8. The felt of claim 1 in which the radicals R or R′ independently or both have a structure represented by Formula (I), 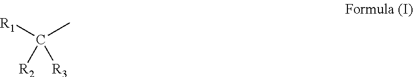
wherein R₁, R₂, and R₃ are selected from the group consisting of:
H;
a primary, secondary, or tertiary alkyl group having from 6 to 18 carbon atoms, optionally substituted with fluoride, chloride, bromide, iodide, nitro, hydroxyl, and carboxyl groups;
an aromatic group having from 6 to 18 carbon atoms, optionally substituted with alkyl, fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups;
with the proviso that when R₂ and R₃ are H, R₁ is:
a secondary or tertiary alkyl group having from 6 to 18 carbon atoms, optionally substituted with fluoride, chloride, bromide, iodide, nitro, hydroxyl, and carboxyl groups;
an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups.

9. The felt of claim 1 in which the radicals R or R′ or both have a structure represented by Formula (I), and R₃ is H.

10. The felt of claim 1 in which the radicals R or R′ independently or both have a structure represented by Formula (II), 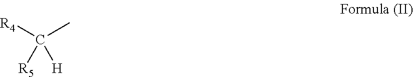
wherein
R₄ is a primary, secondary, or tertiary alkyl group having from 4 to 6 carbon atoms, optionally substituted with fluoride, chloride, bromide, iodide, nitro, and hydroxyl groups; and
R₅ is a methyl, ethyl, n-propyl, sec-propyl, n-butyl, sec-butyl, or tert-butyl group, optionally substituted with fluoride, chloride, bromide, iodide, nitro, and hydroxyl groups.

11. The felt of claim 1 in which the radicals R and R′ are the same and both have a structure represented by Formula (II), R₄ is n-butyl, and R₅ is ethyl.

12. The felt of claim 1, wherein the polyarylene sulfide is polyphenylene sulfide.

13. A bag filter comprising the filter felt of claim 1, the bag filter having a tubular section, one closed end and one open end, wherein the filter felt is a nonwoven felt and forms at least the tubular section of the bag filter.

14. A method for filtering industrial waste gases consisting of the steps of;
(i) providing a flow of dust laden gas,
(ii) allowing all of the flow of gas to impinge upon a filter felt while monitoring the pressure drop of the gas across the filter felt,
(iii) applying a back pulse to the filter felt in the opposite direction of the filter felt when the pressure drop reaches a predetermined level,
wherein the filter felt has a permeability and comprises a nonwoven web comprising fibers, said fibers comprising a composition containing polyarylene sulfide (PAS) wherein the polyarylene sulfide comprises a zinc additive in which the zinc additive is a linear or branched zinc(II) carboxylate selected from the group consisting of Zn(O₂CR)₂, or Zn(O₂CR)(O₂CR′), or mixtures thereof, where the radicals R and R′ are independently hydrocarbon chains or substituted hydrocarbon chains, and if the hydrocarbon chains are alkyl chains then the carboxylate moieties O₂CR and O₂CR′ independently represent either linear or branched carboxylate anions with the proviso that if R and R′ are both linear, then either one of them or both of them independently contains nine or less carbon atoms.
